(19) United States
(12) Patent Application Publication
(10) Pub. No.: US 2020/0078148 A1
(43) Pub. Date: Mar. 12, 2020

(54) Non-Surgical Anti-Aging Denture Facelift System

(71) Applicant: Vahid Dan Danaei-Moghaddam, Vaughan (CA)

(72) Inventor: Vahid Dan Danaei-Moghaddam, Vaughan (CA)

(21) Appl. No.: 16/684,210

(22) Filed: Nov. 14, 2019

Related U.S. Application Data
(63) Continuation-in-part of application No. 15/807,571, filed on Nov. 8, 2017, now abandoned.

(51) Int. Cl. A61C 13/08; A61C 9/00; A61C 19/045; A61C 13/00; A61C 13/34; A61C 13/02

(52) U.S. Cl. CPC A61C 13/082; A61C 9/0006; A61C 13/02; A61C 13/0028; A61C 13/34; A61C 19/045

(57) ABSTRACT

Various embodiments of improved methods of creating removable or fixed over-implant dentures are disclosed that make patients look younger without plastic surgery. Different combinations of dentures may be used. The Denture facelift System (DFS) improves the “look” of virtually some facial defects or aging wrinkles, improves appearance as called anti-aging. These methods provide state-of-the-art dentures while decreasing the number of clinic visits for the patient. The embodiments employ specialized impression trays, a facial and bite registration instrument, and teeth selection kit strips of films to increase the efficiency of the denture-making process. The facial registration instrument comprises adjustable rods and plates to secure a temporary measuring grid above the patient's face, allowing for more accurate marking of anatomical features on wax bite blocks.

### CROSS-REFERENCE TO RELATED APPLICATION(S)

The present application is related to and claims priority to U.S. Non-Provisional patent application Ser. No. 15/807,571, filed on Nov. 8, 2017, pending, which is incorporated by reference in its entirety.

### BACKGROUND OF THE INVENTION

Dentures (false teeth) are prosthetic devices constructed to replace missing teeth; as conventionally manufactured, the surrounding soft and hard tissues of the oral cavity support the dentures when worn. Conventional dentures are removable as with a removable partial or complete denture. However, there are many denture designs, some of which rely on bonding or clasping onto teeth or dental implants. These are sometimes known as fixed prosthodontics. There are two main categories of dentures: dentures that replace missing teeth on the mandibular arch or dentures that replace missing teeth on the maxillary arch.

Many people in modern society are concerned with their appearance and strive to look young despite age taking a toll on their face and body. Many people look to cosmetic surgery to make desired changes to various body parts, but plastic surgery may be dangerous. As people age, their teeth and gums also tend to recede. This movement causes additional wrinkling around the mouth as the unsupported skin folds sag, a condition that the loss of skin elasticity exaggerates. Many people would like to look young yet not compromise health to do so. Thus, a suitable, affordable, non-invasive solution is desired.

U.S. Pub. No. 2006/0172262 to Craig Bruce relates to cosmetic prosthesis and methods for making the same. The described cosmetic prosthesis and methods for making the same includes a cosmetic prosthesis designed to provide non-invasive, removable enhancement of upper and lower lip, being intended to contour and push the facial skin around the mouth and jaw outward, reducing the appearance of wrinkles or aging lines.

### SUMMARY

A denture facelift system (DFS) comprising upper and lower modified impression trays; a vertical-and-horizontal-bite-registration face bow transfer instrument, and teeth selection kit strips having flexible clear films. The teeth strip contains a visual representation that matches the standard shade, shape, and arrangement of a setup of upper and lower anterior artificial teeth. The teeth strip is configured to mount to a patient's mouth using a wax registration bite blocks.

The vertical-and-horizontal-bite-registration face bow transfer instrument comprises a base, Level-A front- and side measuring guides, Level-B front and side measuring guides penetrated and spaced apart by Type-A vertical pins. The base also comprises registration aides comprising an earplug extending headwards from a Level-A side measuring guide and arranged to contact a patient's ear and a U-shaped plate extending headwards from a midline piece and arranged to sit between wax blocks in a patient's mouth. Some embodiments contain additional registration aides, including a chin rest, forehead rest, and eyeglasses.

In some embodiments, the upper and lower impression trays have cutbacks to provide extra room for the intraoral anatomy providing a free space for muscular movements and allowing proper recording during the procedure and proper resting as the impression material cures.

Additionally, the invention covers various methods related to the systems.

### BRIEF DESCRIPTION OF THE DRAWINGS

The figures which accompany the written portion of this specification illustrate embodiments and methods of use for the present disclosure.

FIG. 1 is a perspective view of DFS during an ‘in-use’ condition, according to an embodiment of the disclosure.

FIG. 2 is a perspective view of the DFS of FIG. 1.

FIGS. 3A and 3B arch perspective views of upper and lower impression trays of the DFS.

FIG. 4 is a perspective view of the DFS registration instrument as installed on a patient.

FIG. 5 is a perspective view of the instrument of FIG. 4.

FIGS. 6A and 6B are front and rear views of tooth strips of the DFS.

The various embodiments of the present invention will be described with the appended drawings, wherein like designations denote like elements.

### DETAILED DESCRIPTION

The embodiments of the invention described are exemplary, and numerous modifications, variations, and rearrangements can be readily envisioned to achieve substantially equivalent results. All these variations are within the spirit and scope of the invention.

As discussed above, embodiments of the present disclosure relate to an anti-aging means and, more particularly, to a DFS as used to prepare dentures that improve the facial look and tone of a user.

A denture is an oral appliance that provides artificial teeth held rigidly in a mount that the user wears to restore some chewing ability lost by losing natural teeth. For purposes of this disclosure, a facelift is a modification of the tautness of an individual's facial skin to downplay the effects of aging and wrinkles.

The DFS involves a new line of high precision Impression, clinical, in-lab, processing materials, and products. The DFS supplies a package that includes a tool kit including bite registration and high precision measuring tools; high precision, film-based tooth strips showing shade and shape of artificial teeth; and sets of in-lab material and adjustment tools suitable for DFS.

In some embodiments, a denture or partial denture provides the typical function of dentures and ameliorates wrinkles by tightening facial skin. In some versions, aspects that contribute to tightening facial skin include thickness and height of the denture base and size and placement of the teeth, etc.

A DFS denture can have features that provide cosmetic enhancements. In some versions, cosmetic enhancements include tighter skin to remove facial wrinkles or to provide a facelift effect. Cosmetic enhancements include tightening facial skin or tightening facial skin sufficiently to reduce skin wrinkles. In some cases, cosmetic enhancement arises from adjusting denture gum area or gum region geometry. In some cases, cosmetic enhancement arises from providing lip support.

DFS dentures are made similarly to conventional dentures.

For instance, accurate measurements of the user's mouth must be taken. Traditionally, such measurements, starting with taking intraoral imprints, were taken directly with any impression materials. To achieve measurement accuracy sufficient for DFS dentures to provide cosmetic enhancements, high-performance one-step final impression DFS Tray & Silicone two-tone heavy and wash impression material. For instance, materials that record and maintain accurate gum impressions can be materials that minimize shrinking or other dimensional changes that can occur as the mold material cures. Also, bite blocks can be used to help determine correct amounts of support material for providing cosmetic enhancement as well as DFS one-step bite registration instrument and teeth selection kit strips.

Alternatively, 3D CAD/CAM equipment, such as an intraoral scanner, may be used in the process of making the models. The scanner collects measurement data to make a physical or computer model of the interior of the user's mouth. The scanner collects upper and lower jaw data and collects attached muscle data, as well. By scanning the jaw relations in a relaxed jaw position with lips in contact, scanning registers the bite pattern. Scanning determines the amount of lip and cheek support that the DFS dentures may need to provide.

Thus, the CAD system generates digital results that appear on the screen for the user to confirm, through DFS software applications, the user-selectable parameters of the dentures. After that, digital lab machinery machines the final DFS dentures.

This process creates DFS dentures correctly shaped to provide replacement dentition and cosmetic enhancement. These dentures allow cosmetic improvements without using oral inserts or appliances and allow cosmetic improvements without surgery. With better molds and models, the resulting DFS denture can fill the mouth more naturally and provide sizing and fit to tighten chin, mouth, and cheek skin to provide cosmetic enhancement.

Generally speaking, the present invention provides a system for preparing a combination of partial or complete, upper, lower, or both dentures involving the bite registration process and having teeth set up to open a vertical dimension and more or less add the height and the thickness of the flange (gum) if necessary to provide the described function. The DFS will improve some facial defects or aging wrinkles by opening proper vertical dimension, leaving at least 3 mm free-way space between maxillary & mandibular teeth, for proper mastication.

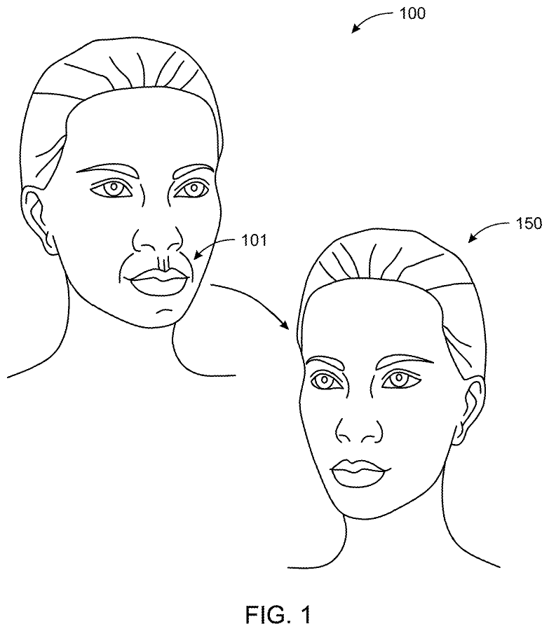

Referring now more specifically to the drawings by numerals of reference, FIGS. 1-6B show various views of the DFS 100.

FIG. 1 shows dentures from DFS 100 during an ‘in-use’ condition 150, according to an embodiment of the present disclosure. Here, dentures formed using DFS 100 may promote proper facial orientation. Facial wrinkles 101 are smooth when the DFS dentures are worn. DFS 100 may provide upper denture 120 and lower denture 130 that support surrounding soft and hard tissues of an oral cavity of a user and help maintain a desired vertical face structure.

The clinician uses a bite registration process to form dentures using components from DFS 100. The DFS manufacturing process may heighten and thicken gum or artificial denture teeth section 118 to achieve the desired free-way space. DFS 100 allows the clinician to accurately record and measure for dentures, which allows the dentures to better horizontally and vertically position and function based on muscular, facial, and bone structure.

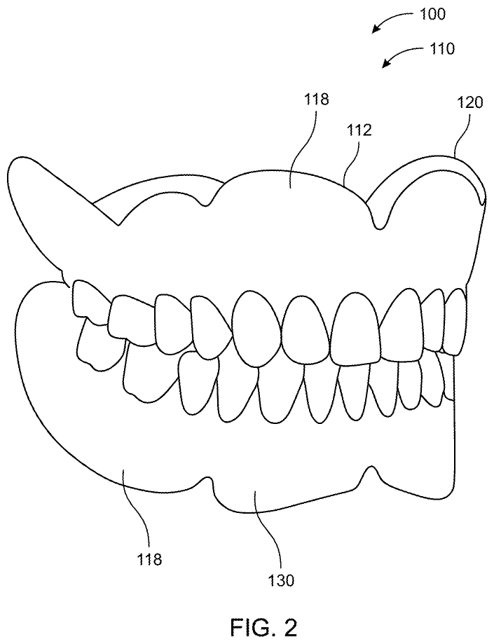

As FIG. 2 shows, in these or alternative embodiments, DFS 100 may provide components to accurately measure for a dental prosthetic appliance 112, allowing the production of appliance 112 with an extended gum section 118. Appliance 112 leaves a free-way space of at least 3 mm between maxilla and mandible teeth. DFS 100 allows the clinician to accurately measure for the appliance, which allows the appliance to better horizontally position muscle and orient bone structure.

The appliance may only be an upper in certain embodiments and only a lower in other embodiments or may comprise an upper and a lower. Extension of gum section 118 is achieved through a height increase, a thickness increase, or a height increase and a thickness increase, in combination.

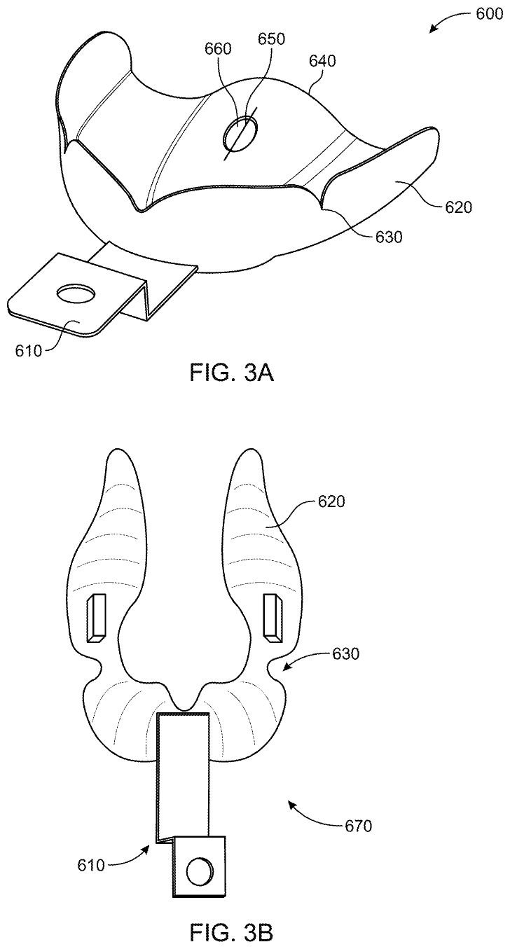

FIG. 3A shows an upper impression tray 600 for use with DFS. Upper tray 600 offers a more accurate, time-saving, and cost-effective border-molding system based on proper cutouts 630 and aligned border 640. In this embodiment, upper tray 600 has handle 610, body 620, cutouts 630, aligned border 640, palatal groove 650, and touch point 660. FIG. 3B shows a lower impression tray 670 for use with DFS. Lower tray 670 is for taking lower jaw impressions. This embodiment shows lower tray 670 with handle 610 and cutouts 630. Cutouts 630 in upper tray 600 and lower tray 670 provide more space for the intraoral anatomy and free muscular movements to function and rest undisturbed as the impression is taken, which leads to impressions that better match the real shape of the anatomy during function and rest. Having more space also allows for more realistic muscle movement and position. All of this leads to more accurate impressions. Additionally, palatal groove 650 provides space for accurately recording impressions of palatal tori, also increasing the accuracy that lower tray 670 and upper tray 630 provide.

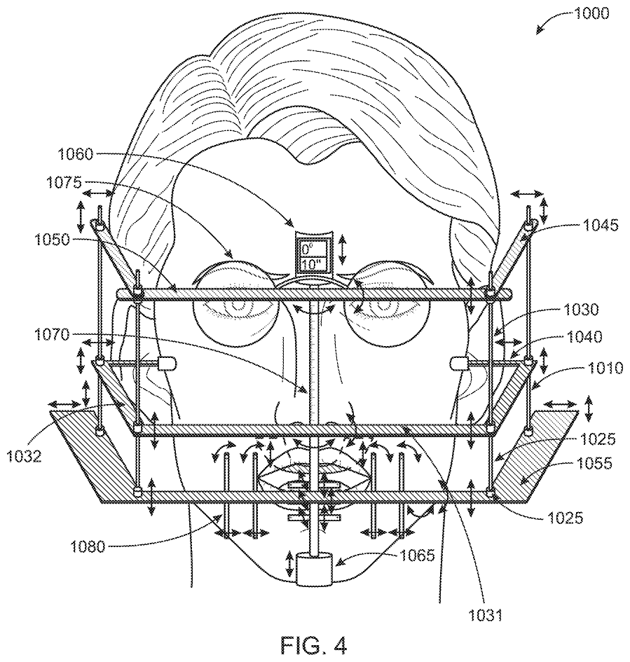

FIG. 4 shows a DFS one-step, vertical-and-horizontal-bite-registration face bow transfer instrument 1000 according to an embodiment of the invention.

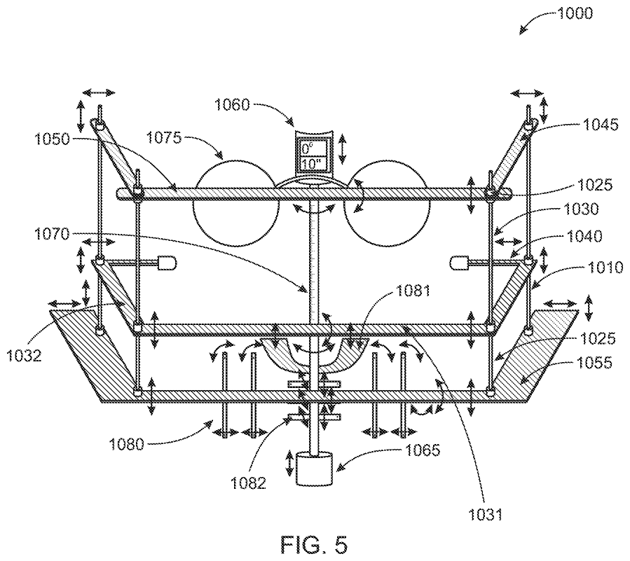

FIG. 5 also shows a DFS one-step vertical-and-horizontal-bite-registration instrument 1000 according to an embodiment of the invention. This document also calls instrument 1000 a bite registration face bow instrument. Instrument 1000 allows the clinician to accurately measure and mark relevant parameters during the bite registration step, among others. Instrument 1000, once adjusted to the patient's face, registers with the patient's face and, when registered, provides a fixed framework or grid marks onto the blocks that the clinician uses to measure the patient's facial and intraoral anatomy onto the wax blocks or bite blocks.

Instrument 1000 has Type-A vertical pin 1010 that extends up the cheeks of a DFS patient and has horizontal base 1055 connected to Type-A vertical pin 1010. A bushing 1025 connects Type-A vertical pin 1010 to base 1055 to allow a hinge-type action. This arrangement occurs on both sides of the face. Bushing 1025 connects Level-A front measuring guide 1031 to Type-B vertical pin 1030 on each end of guide 1031, and bushing 1025 connects Level-B front measuring guide 1050 to Type-B vertical pin 1030 on each end of guide 1050. Type-B vertical pin 1030 connects Level-A front measuring guide 1031 to Level-A side measuring guide 1032 at each end of Level-A front measuring guide 1031. Level-A side measuring guide 1045 connects to horizontal base 1055 through Type-A vertical pin 1010 and Type-B vertical pin 1030. Level-B side measuring guide 1032 connects to horizontal base 1055 through Type-A vertical pin 1010, and Type-B vertical pin Type-A vertical pin 1030 connects Level-B front measuring guide 1050 to Level-B side measuring guide 1045 at each end of Level-B front measuring guide 1050.

Earplug extensions 1040 that extend out from Type-A vertical pin 1010, mid-eyebrow rest 1060, and chin rest 1065 connected by midline piece 1070 help position device 1000. To help position device 1000 further, device 1000 has eyeglass 1075. These also help to protect the patient's eyes. Device 1000 also has U-shaped plate 1082 that fits between bite blocks. Registry pins 1080 pass through horizontal base 1055. The clinician uses these to mark or draw lines into the wax block.

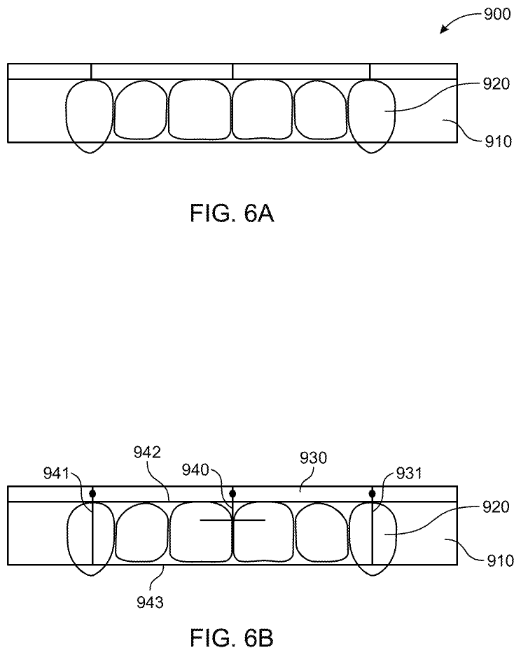

FIGS. 6A-6B shows a particular version of tooth strip 900. Strip 900 is a component of the DFS teeth selection set. The set offers a preview of how the artificial teeth will look once set into the dentures (or appliance). The teeth selection set replaces standard teeth selection processes. Strip 900 depicts the size, shape, and color of the artificial teeth without temporarily setting the teeth in the models. Tooth strip 900 is a flexible film that accurately depicts teeth 920. Additionally, strip 900 has an upper mount 930 that connects to the top edge of strip 900. In some embodiments, mount 930 comprises metal. Pins 931 extend rearward from mount 930. Pins 931 mark the bite blocks during denture construction, sometimes assisted by heating the pins. In some embodiments, strips 900 have indications for centerline 940, canine line 941, high lip line 942, and low lip line 943.

Tooth strip 900 depicts images of the selected teeth family, and strip 900 can be placed accurately with respect to the bite blocks.

Depicting and placing accurate images of the teeth allows the patient to preview what the dentures (or appliance) will look like after completion without having the actual teeth or models of the teeth present. This makes the process more economical for the patient because the patient can avoid an additional office visit. The system also saves time for both the patient and the clinician because that extra office visit is extraneous. Tooth strip 900 can show the patient how the teeth will look in place. Because the patient has a better idea of what the final dentures will look like, the process can lead to fewer instances of remaking the dentures. The strip system also saves the clinician storage space and upfront costs because the clinician doesn't have to include or maintain a complete library of artificial teeth for fitting and selecting the teeth but instead can maintain a tooth strip library that occupies much less space. The smaller size of the tooth strip library also allows for easier portability, which will serve mobile clinicians.

DFS 100 comprises a kit that contains components that allow a clinician to create a facelift effect in the patient, tightening skin and removing Crow's feet. It also contains components that allow the dentures themselves to be made in fewer office visits than traditional methods. The kit comprises a customized set of impression trays 600, Bite registration instrument 1000, and tooth image film or strips 900, among other possible components.

One-Step Impression Visit

Traditionally, the impression process uses a two-step, preliminary-and-final-impression method requiring two office visits for the patient and lap trips for the device.

The clinician takes impressions using upper impression trays 600 and lower impression trays 670. The clinician fills the DFS impression trays, as is typical. The clinician inserts the upper tray into the patient's mouth to take the impression. During this process, the clinician molds the borders based on the muscular movements, natural lip, and cheek muscle reactions, and general facial musculature while the impression material sets. The clinician massages the face muscles of the Maxillary area back to front, massages the cheeks, massages the lips, pulls the cheeks and upper lip, and asks the patient to open their mouth wide and smile to mold the material as it sets.

Likewise, the clinician fills the lower tray as usual. The clinician inserts the lower tray into the patient's mouth using gentle pressure to install all tray parts on the mandible and places gentle pressure on the handle. The clinician massages the face muscles of the mandible area back to front, cheeks, and lower lip, and pulls the cheeks and lip and asks the patient for certain tongue movements, open mouth wide, bite down, smile, and say “KEG” to mold the material as the material sets.

Since these impression trays have cut out 630, when the clinician molds and manipulates the lips, cheeks, tongue muscles, etc., the clinician records are more accurate impressions than prior art process. At the impression visit, after impressions are taken using upper trays 600 and lower trays 670, the impressions are suitable for use as the final impressions.

From these final impressions, the lab makes stone-cast models and wax bite blocks for bite registration and teeth selection.

### One-Step Appointment for Bite Registration and Teeth Selection

The clinician inserts the upper bite block in the patient's mouth and manually records the smile line, the upper lip line of the upper lip, the lower lip line of the upper lip, the central line, and the upper labial frenum average middle position, etc. After that, the clinician replaces the upper bite block with the lower bite block and manually records the smile line on the lower block and the upper lip line of the lower lip on the block.

The clinician trims block height to size based on the lip lines. Then, with both the upper and lower bite blocks in place, the clinician verifies that there is sufficient vertical space between the upper and lower blocks using traditional methods—at least 3 mm of free space between the blocks.

Then the clinician adjusts for any touch and balance between the bite blocks.

With the blocks in the mouth, the clinician uses the teeth selection kit strips to help the patient find the most desirable shade and shape of the teeth by attaching tooth strip or strips 900 to the blocks. This allows the patient to get an accurate representation of what the final dentures will look like. Various pins 930 also mark the registered lines again based on the strip's position on the wax blocks.

After that, the clinician installs the DFS bite registration, all-in-one, face bow instrument 1000 following the kit instruction in the mouth and on the face The mid-eyebrow rest 1060 rests on the patient's forehead. Then the various measuring bars, Type-A vertical pin 1010, horizontal base 1055, Level-A front measuring guide 1031, Level-A side measuring guides 1032, Level-B front measuring guide 1050, Level-B side measuring guide 1045, chin rest 1065, and eyeglass 1075 are adjusted until they contact the patient's face and facial structure, or are otherwise adjusted, so that instrument 1000 is correctly registered with the patient's face. Once that registration is complete, instrument 1000 forms a fixed and accurate position or registration between the face and the wax bite blocks. This sets up instrument 1000 for the final precision measurements and precision line drawings on the blocks. Using this accurate registration, the clinician can use knives or other tools to mark the reference lines using the measuring framework accurately held in place on the patient's face. The clinician uses the instrument 1000 to leave marks on the wax block, making sure marked lines match with manually drawn lines and marked lines by teeth selection strip.

After ensuring the proper measures, lines, and positioning. The clinician removes the DFS registration instrument 1000 and then uses one-step silicone bite registration material to record the block's position with respect to each other. These blocks are sent to the lab for final teeth setup with DFS desired precision quality denture teeth, and also DFS dentures final processing with DFS desired precision quality denture processing materials traditional or digital.

In the last clinical step, any final adjustments are made to the dentures ready to use.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for enhancing skin look and proper facial positioning via the DFS 100 are taught herein.

The embodiments of the invention described herein are exemplary, and numerous modifications, variations, and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A denture facelift system comprising upper and lower impression trays; and a vertical-and-horizontal-bite-registration face bow transfer instrument.

2. The system of claim 1 further comprising a tooth strip having a flexible film.

3. The system of claim 2, wherein the tooth strip contains a visual representation that matches the color, shape, or arrangement of a set of artificial teeth.

4. The system of claim 3, wherein the tooth strip is configured to mount to a patient's mouth using the waxed bite blocks.

5. The system of claim 4, wherein the instrument comprises a base, a Level-A front measuring guide, and a Level-B front measuring guide penetrated and spaced apart by a Type-A vertical pin.

6. The system of claim 5 further comprises Level-A side measuring guides, Level-B side measuring guides, and the base, wherein Level-A side measuring guides and Level-B side measuring guides are penetrated and spaced apart by a Type-B vertical pin.

7. The system of claim 6, wherein the instrument has registration aides comprising an earplug extending headwards from a Level-A side measuring guide and arranged to contact a patient's ear.

8. The system of claim 7, wherein the registration aides further comprise a U-shaped plate extending headwards from a midline piece and arranged to sit between wax blocks in a patient's mouth.

9. The system of claim 8, wherein the registration aides further comprise a chin rest, forehead rest, and eyeglasses.

10. The system of claim 9, wherein the upper and lower impression trays have cutbacks to provide extra room for the intraoral anatomy and free space for intraoral muscular movements and to rest properly as the impressions cure.

11. The system of claim 3, wherein the upper and lower impression trays have cutbacks to provide room for the intraoral anatomy to rest properly as the impressions cure.

12. The system of claim 1, wherein the instrument comprises:
a base,
a Level-A front measuring guide,
and
a Level-B front measuring guide penetrated and spaced apart by a Type-A vertical pin;
and
Level-A side measuring guides,
and
Level-B side measuring guides,
wherein the base, Level-A side measuring guides, and Level-B side measuring guides are penetrated and spaced apart by a Type-B vertical pin.

13. The system of claim 12 wherein the instrument has registration aides comprising:
an earplug extending headwards from the Level-A side measuring guide and arranged to contact a patient's ear;
and
a U-shaped plate extending headwards from a midline piece and arranged to sit between wax blocks in a patient's mouth.

14. The system of claim 13, wherein the registration aides further comprise a chin rest, forehead rest, and eyeglasses.

15. The system of claim 14, wherein the upper and lower impression trays have cutbacks to provide room for the intraoral anatomy to rest properly as the impressions cure.

16. A method of using a DFS comprising:
providing the DFS of claim 1;
providing impressions;
providing bite blocks;
installing bite blocks in a patient's mouth;
installing the bite registration instrument on the patient's face;
marking reference marks on the bite blocks.

17. The method of claim 16 wherein the instrument has registration aides comprising an earplug extending headwards from a Level-A side measuring guide and arranged to contact a patient's ear.

18. The method of claim 17, wherein the registration aides further comprise a U-shaped plate extending headwards from a midline piece and arranged to sit between wax blocks in a patient's mouth.

19. The method of claim 18, wherein the registration aides further comprise a chin rest, forehead rest, and eyeglasses.

20. A method of making dentures or a dental appliance comprising:
providing a denture facelift method having dental impression trays, a vertical-and-horizontal-bite-registration face bow transfer instrument, and a teeth selection strip comprising a clear, flexible film;
forming impressions using the customized impression trays;
mounting the bite registration instrument on a patient's face;
making registration marks on a wax block;
installing the teeth selection strip;
and
completing final teeth setup and DFS denture processing.
